(19) United States
(12) Patent Application Publication
(10) Pub. No.: US 2024/0143959 A1
(43) Pub. Date: May 2, 2024

(54) METHOD AND SYSTEM FOR USAGE OF A PERSISTENT LABEL

(71) Applicant: John Wechsler, Fishers, IN (US)

(72) Inventor: John Wechsler, Fishers, IN (US)

(21) Appl. No.: 18/384,039

(22) Filed: Oct. 26, 2023

Related U.S. Application Data
(60) Provisional application No. 63/381,209, filed on Oct. 27, 2022.

(51) Int. Cl. G06K 7/14

(52) U.S. Cl. CPC G06K 7/1417

(57) ABSTRACT

A system and method are described for using a persistent label is described. A system for customization of a response based on a number of labels allows for generic, group, lot and unit level customization of a response to a request which comprises an identifier associated with a persistent label.

### BACKGROUND OF THE INVENTION

### 1. Field of the Invention

The present invention is related to systems for using a persistent label. Specifically it relates to a method and system for usage of a persistent label in conjunction with an article of manufacture.

### 2. Description of the Related Art

Persistent labels have been applied in the art for many years. Most manufactured products, such as automobiles, and consumer goods will typically have a serial number, and that serial number will be permanently fixed to the product. Packaged consumer products such as foodstuffs may have lot numbers, date codes, and Stock Keeping Unit (SKU) codes assigned to them. Such labels may include machine-readable components. For example, bar codes have been employed for various purposes. The first Universal Product Code (UPC) was scanned on Jun. 26, 1974. Such codes have been used for inventory tracking and other purposes since that time.

Labels which comprise a machine readable element are well known in the art. A label which includes a Quick Response (QR) code or bar code may be used to identify a type of product. For example, a QR code printed on a package for a product may identify a serial number and model of the product, which may be used to allow traceability of the product. QR codes have become popular as a form of machine readable visual code since the implementation of QR code recognition and browser launch of the associated URL was introduced in iOS 11 in June 2017. Android soon followed with Version 8.0 (Oreo) in August 2017.

Such labels have been used to allow media to be associated with a given label when a Uniform Resource Locator (URL) encoded in a QR code is opened in a browser. The resultant web page may access a video clip which is associated with the URL and begin playing that video content when the URL is received at a server. This type of system has enjoyed commercial success as it may permit a user to associated media, such as a video clip with a particular object. However, such systems may have some problems. For example, a QR code may not comprise sufficient information of a product, or a response to scanning of a QR code may be identical regardless of the type of product and/or lot number, serial number, etc. which may be encoded in a QR code. Because a QR code is universally readable and a usable in any browser, access to information associated with a particular URL and/or QR code may not be suitable.

A dedicated application or App, which may operate on a device such as a mobile phone, tablet, or other computing device, may be employed to optimize a response to a QR code. For example, the Coca-Cola company has deployed the Coca-Cola App for iOS and Android to facilitate the use of Sip & Scan® codes and icons. However, such systems may encounter barriers to use and/or may have limited utility. For example, a user may be reluctant to download a dedicated app, a label may not contain sufficient information to allow a customized response, etc.

For these and other reasons, an improved method for usage of a persistent label would be greatly appreciated.

### SUMMARY OF THE INVENTION

A method and system for usage of persistent labels is described. A persistent label comprises a machine readable code such as a QR code. A persistent label may be printed, engraved, and/or otherwise affixed to an article of manufacture and/or other object. A portion of a URL which is mapped to a persistent label may identify the label as a persistent type. A package which may comprise a number of items and/or articles of manufacture may be assigned a persistent label. An image of security information associated with a label may be stored in a user device, which may permit a user to utilize access rights to a label without providing additional security information. A system which assigns an identifier to a label and/or article may control content, media and/or access rights associated with a persistent label. A user may be permitted to read, write, download, and/or modify content associated with a label. A user may be permitted to modify access rights for others that may access content via a URL associated with a label.

A multi-faceted approach to creating a response to product labeling is described. In an embodiment, a fixed label is applied which is traceable to a unit level, Unit Level Traceability (ULT). In such an instance, a response to scanning of the label may be modified based on information of the product. Depending on the type of product ULT may be implemented by application of a label at a point at which a product is completely differentiated. For example, a beverage container might receive a label which uniquely identifies a unit of production which is subsequently packaged in a larger group. Recording of a unique identifier of a unit enables later responses in an adaptive manner. In the case of a beverage container, a scan of a unit identifying label might access a promotional website so long as there is no specific information which might differentiate that unit. However, if there is specific information associated with a unit, such as a product recall issue, a response would be provided to permit a warning to a consumer, and a bidirectional communication between a manufacturer and a consumer.

In a different example. a medical product such as a bandage, a response might cause a response to be triggered by other information. For example, if a product is dispensed by an emergency room or immediate care facility, the facility might scan the label when it is dispensed. A subsequent scan of the label might guide a patient to instructions for follow-up care and/or other care practices. If the same product were purchased at a retail outlet, a scan of the identifying label might direct a user to instructions for usage. Likewise if a product were the subject of a promotional campaign, a scan of the identifying label might bring a user to a promotional website during the time of the promotion, and to a generic website before and/or after the promotional period had ended.

In another aspect of the invention, a label associated with a medical device such as a bandage might be used to provide a referral to a provider of follow-up care. For example, a label might be scanned at the location where care is provided and linked to information of the provider and the patient. A subsequent scan of the label might direct a user to a care provider determined by the location of the patient, the provider of the device, or a suitable combination of information regarding the provider, the patient, and/or other factors.

As noted above, ULT may not always be possible from a practical standpoint. For example, for cost reasons, product packaging may be produced using technologies such as offset printing which are not easily amenable to variable label printing. In such an instance, multiple forms of labeling may be mixed to achieve a response. Using the example of the beverage container, a generic label might be printed on a unit, while variable labeling might be applied to a package. In such an instance, a scan of the generic label might direct a user to a generalized website. Upon accessing the generic site, a user might be offered an option to input more specific product information by manual and/or machine readable entry. Such an input might then be used to customize a response to a particular product group, which might be a regional or local response.

### BRIEF DESCRIPTION OF DRAWINGS

Aspects and advantages of the disclosure will become apparent and more readily appreciated from the following description of the embodiments, taken in conjunction with the accompanying drawings, of which:

FIG. 1 is a block diagram of an exemplary system embodiment.

FIG. 2 is a schematic representation of an exemplary persistent label.

FIG. 3 is a schematic representation of an exemplary persistent label applied to a packaged product.

FIG. 4 is a schematic representation of an exemplary persistent label applied to a packaged product which comprises a secondary persistent label.

FIG. 5 is a flowchart of creation of a persistent label.

FIG. 6 is a flowchart of associating a response to an identifier with a number of persistent labels.

FIG. 7 is an exemplary user interface for associating a response with a persistent label.

### DETAILED DESCRIPTION OF THE INVENTION

Reference will now be made in detail to the present embodiments discussed herein. Examples are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein, words importing the singular shall include the plural and vice versa unless specifically counter indicated.

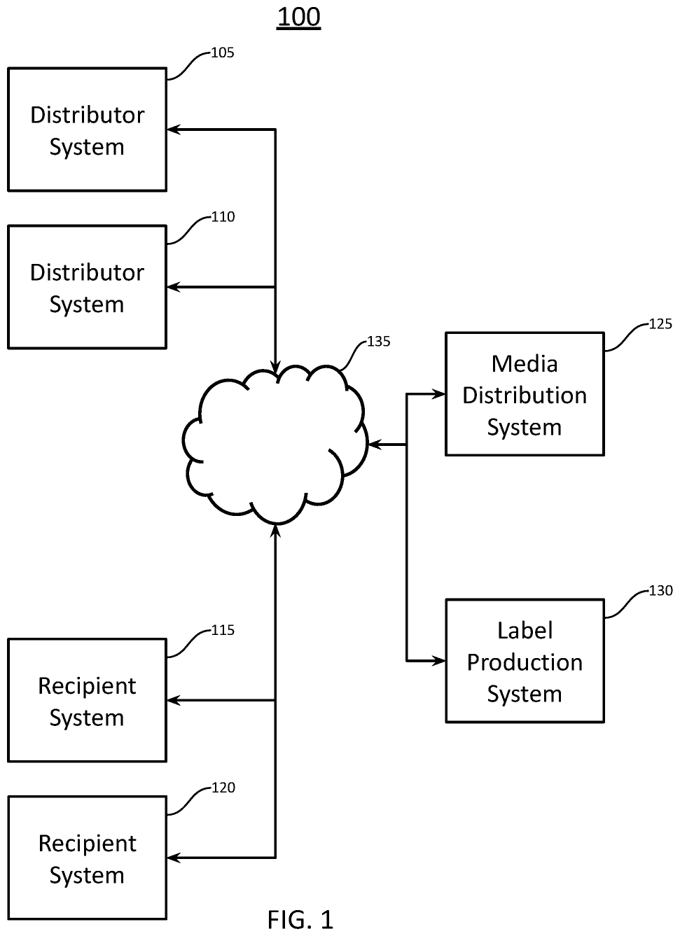

As illustrated in FIG. 1, a system 100 may comprise distributor systems 105, 110, recipient systems 115, 120, a media distribution system 125, a label production system 130, and a network 135. The distributor systems 105, 110, may be any suitable devices which can implement the functions necessary to operate the embodiments. For example, a mobile phone, a tablet computer, a laptop computer, a desktop computer, and/or any device which may perform image acquisition and/or processing, data storage, audio acquisition and processing, data display and/or network operations may be a distributor system. The recipient systems 115, 120 may similarly be any suitable device which may implement the functions required to operate the embodiments. For example, a mobile phone such as an iPhone® 13, or a tablet computer such as a Samsung Galaxy® S8, or a Dell XPS® 13, might be used as a recipient system. The media distribution system 125 may be any suitable hardware which may implement a server and media storage. For example a Dell PowerEdge® rack server operating on the Ubuntu® Linux operating system with suitable storage media might be used to implement a media distribution system. Hardware provided by a cloud computing service provided such as Amazon Web Services® (AWS) and/or Microsoft Azure® might be used to implement a media distribution system. Computing operations to implement a media distribution system might be performed based on instructions implemented in any suitable programming language such as Python, Java, etc. A database functionality of a media distribution system might be implemented using a software system such as MongoDB, Microsoft SQL, and/or other available commercial database products which implement an equivalent functionality.

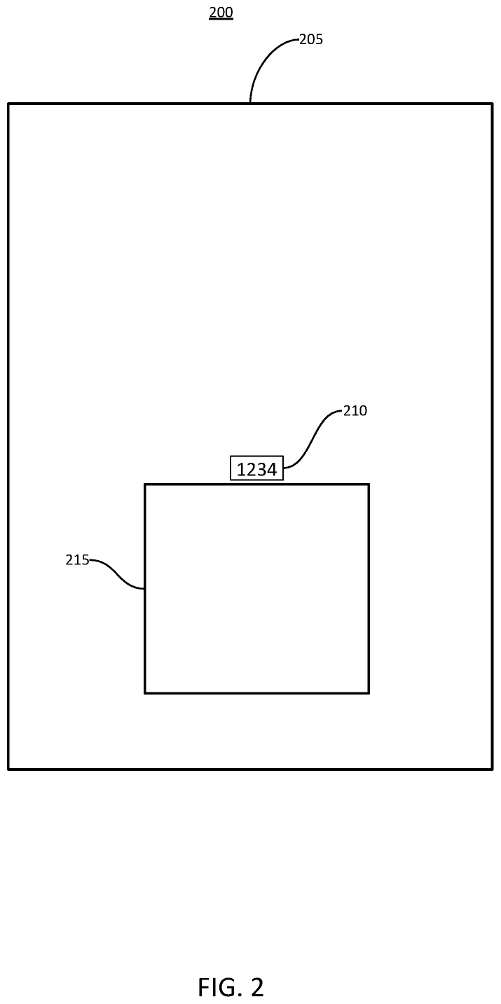

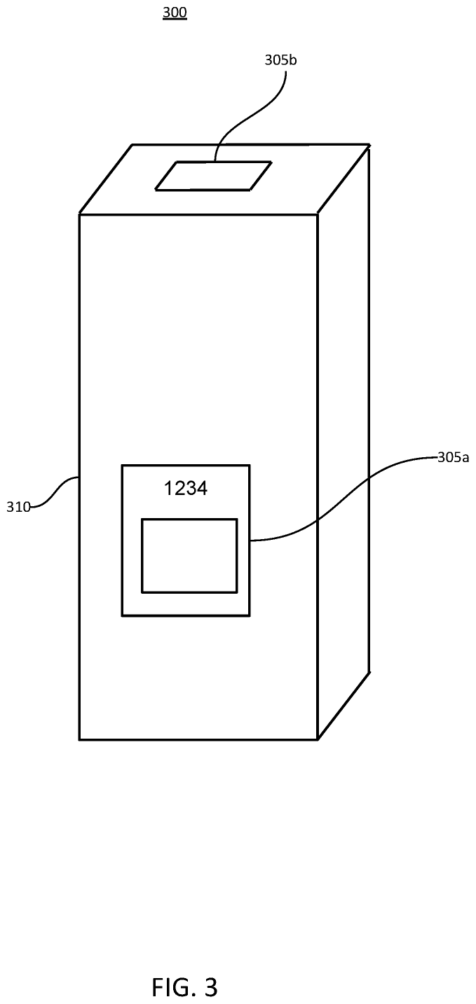

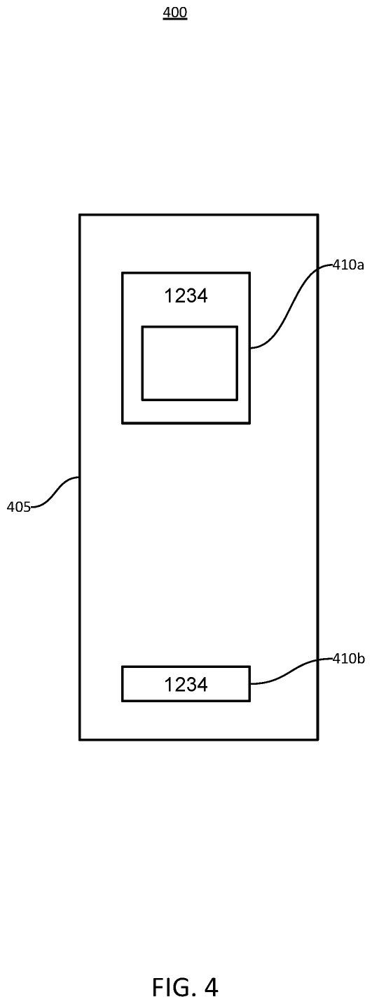

The label production system 130, may be implemented using any suitable hardware such as that used to implement a media distribution system and/or a purchaser system. The label production system 130 comprises hardware for producing a label such as that illustrated in FIG. 2 as well as generating and applying secondary or auxiliary labels such as those illustrated in FIG. 3 and FIG. 4. The label production system 130 may exchange information with the media distribution system 125 in order to ensure that labels incorporate correctly encoded identifiers associated with an unique identifier of a label and/or tracking data of a product or article of manufacture. For example, a QR code associated with a label may be mapped to a designated unique identifier of a label. Symbols such as icons, graphics, letters, numbers, etc., which may provide information associated with a unique identifier of a label may be printed and/or otherwise physically recorded on a label by suitable hardware controlled by the label production system 130. For example, a digital printing process such as ink jet printing might be used to apply symbols and/or machine readable codes to packaging of a product, to an individual product and/or to a package of products by a label production system. As further described herein, labels may be applied at various points in a production and/or distribution process. For example, a label might be applied to an individual article, a packaged group of articles, a package which comprises a number of articles, and/or any suitable combination thereof. A label production system may comprise multiple hardware elements, which are used to apply durable markings as labels to an article. Processes such as stamping, embossing, engraving, printing, heat transfer, photographic and/or laser etching, and other suitable marking technologies may be controlled by elements of a label production system.

The network 135 may comprise any number of public and/or private networks. The network may comprise wireless communications such as WiFi®, LiFi®, 3G®, 4G® and/or 5G® telephone networks, and/or terrestrial and/or satellite communications networks. The network 135 allows communication to occur between the various components of the system 100. Based on the disclosure herein one of ordinary skill will immediately understand that any suitable communication network which is well known in the art may be used as an element of the network 135. While a limited number of distributor systems, recipient systems, media distribution systems, and label production systems are illustrated in FIG. 1, it is envisioned that many such systems would be operative in a typical embodiment.

A persistent label 200 is illustrated schematically in FIG. 2. The persistent label 200 may comprise a substrate 205, a symbols area 210 and a machine readable area 215. The substrate 205 may be any material which is able to receive a durable marking and which can provide a suitable surface for a selected machine readable marking. For example, paper, plastic, metal, fabric, ceramic and/or other similar materials might be used as the substrate 205. The symbols area 210 and the machine readable area 215 are durably marked on the substrate 205. The symbols area 210 may comprise a number of symbols which may be printed on the surface of the persistent label 200. Symbols such as alphanumeric characters, and/or icons, etc. may be contained within the symbols area 210. In an embodiment, the symbols area 210 comprises a numeric code. In an embodiment, the symbols area 210 comprises a word associated with a unique identifier associated with the persistent label 200. The machine readable area 215 may comprise a machine readable element such as a QR code, bar code and/or other type of machine readable optical code which is well known in the art. In an embodiment, the machine readable area 215 comprises a QR code which encodes information of an identifier assigned to the persistent label 200.

A package 300 of articles of manufacture which incorporates a number of persistent labels 305a-305b is illustrated in FIG. 3. The package 300 may comprise a number of persistent labels and a substrate 310. The persistent labels 305a-305b may be assigned a unique identifier. In an embodiment, each of the persistent labels 305a-305b is assigned to a different unique identifier. In an embodiment, a persistent label is applied which indicates a product type (e.g. a SKU), and a persistent label is applied which may indicate a batch number, production date, and/or other variable label which is uniquely associated with a package such as the package 300. The substrate 310 may incorporate properties which allow a persistent marking such as the persistent labels 305a, 305b to be adhered to the substrate 310 in a manner which may cause a label to be damaged if an attempt is made to remove the label. Different types of labeling techniques may be applied to a package such as the package 300. For example, the persistent label 305a may be a printed label which is produced using a process such as silk screening, offset printing and/or other high volume printing methods. The persistent label 305b might be a stamped code which is embossed on the substrate 310 when a group of articles are packed for shipment or distribution. In an embodiment such as that depicted in FIG. 3, the combination of content indicated by the persistent labels 305a, 305b might be used to uniquely identify the package 300, which might comprise any number of articles. Similarly, persistent labels might be applied to articles contained in the package 300, which might also be used to uniquely identify a number of the articles.

An alternate embodiment of article of manufacture 400 which comprises a plurality of persistent labels is depicted schematically in FIG. 4. The article 400 may comprise a substrate 405 and a number of persistent labels 410a, 410b. The article 400 may be a product which has a generic type as indicated by the persistent label 410a. For example, a wrapper of a bandage, a package of food, and/or other type of product might comprise a persistent label such as the persistent label 410a. Such a persistent label might be identical for all of the articles of manufacture, and may comprise such features as the persistent label 205 (FIG. 2). The persistent label 410b may be applied to the article 400 and attached to the substrate 405 by a distributor of the article 400. As such the persistent label 410b might be used to differentiate an article from a generic version of that article. The substrate 405 may be common between the persistent labels 410a, 410b and/or may be different as is suitable for a given use case. For example, a package of a bandage or wound dressing might have a persistent label which is generated by a manufacturer of the bandage, which would be indicated by the persistent label 410a. A distributor of the bandage might apply a different label to the package based on suitable criteria, such as a distribution channel (e.g., first aid kit, dispensed at a care center, etc.), which might be the persistent label 410b. Detection of the persistent label 410a and/or the persistent label 410b might be used to provide care instructions, refill information, and/or referral to services for a recipient of the bandage.

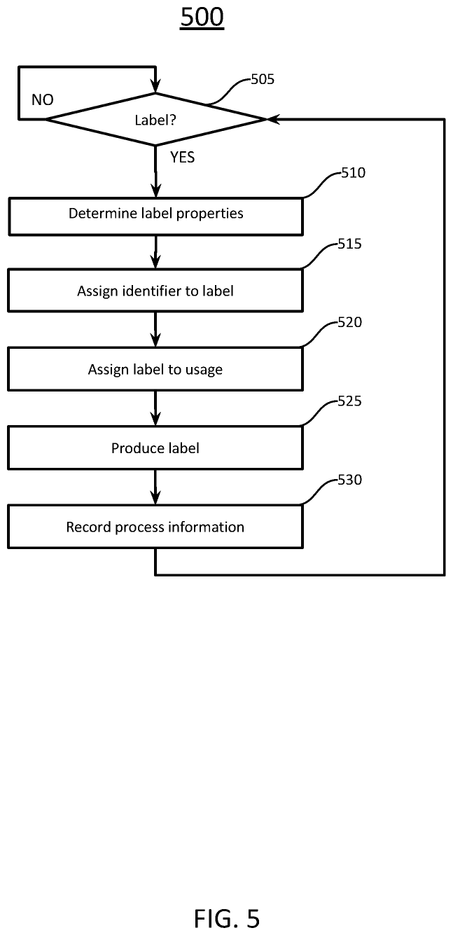

A flowchart of a process 500 for creation of a persistent label is illustrated in FIG. 5. The process 500 may be operative in whole or in part on any suitable elements of the system 100 (FIG. 1). In an embodiment, the process 500 is operative on the label production system 130 in conjunction with the media distribution system 125. In an embodiment, the process 500 may be operative on the distributor system 105 in conjunction with the media distribution system 125 and the label production system 130.

In operation 505 a determination is made as to whether a request to produce a label is received. If in operation 505 it is determined that a request to produce a label is received, control is passed to operation 510 and process 500 continues. If in operation 505 it is determined that a request to produce a label is not received, control remains at operation 505 and process 500 continues.

The determination in operation 505 may be made based on any suitable criterion. In an embodiment, if a request is received at a device associated with the label production system 130 (FIG. 1) it may be determined that a request to produce a label is received. In an embodiment, if a label is scanned by the distributor system 110, it may be determined that a request to produce a label is received. In an embodiment, if a package of product such as the package 300 (FIG. 3) is detected it may be determined that a request to produce a label is received.

In operation 510 properties of a label to be produced are determined. For example, a request may describe physical dimensions (length, width, thickness) of a label, a type of substrate material (e.g., paper, plastic, composite, ceramic, etc.), a type of ink to be used, how a label is to be attached, resistance to water, fire and/or other substances, resolution of printing processes, colors to be used, types of coding for machine readable elements, and/or symbols which may be employed in production of a label. Properties of a label may be based on a type of material which is available. Properties of a label may be determined based on an industry standard. Control is passed to operation 515 and process 500 continues.

In operation 515 an identifier is assigned to a label. In an embodiment, an identifier assigned to a label is unique to the label. An identifier may be assigned based on a standard such as the Universally Unique Identifier (UUID) standard under the Open Software Foundation (OSF). Properties of a label may be associated with an identifier assigned to the label. In an embodiment, an identifier may be associated with a label based on information indicated by a request to produce a label. For example, if a generic type of product is indicated in a request, an identifier associated with a requester and the product type may be used to assign an identifier to a label which is to be produced. Information of a request may be associated with an identifier assigned to a label. For example, geographic location data, a distribution channel, a point of sale, etc., which are associated with a request may be used to determine an identifier assigned to a label. For example, an identifier assigned to a label may be a based on a generic label attached to an article which is scanned by a device which generates and/or initiates a request to produce a label. Control is passed to operation 520 and process 500 continues.

In operation 520 a label is assigned to a usage. For example, a label may be specific to a particular article. Similarly, a label may be designated as a generic label which is not unique to a particular article and may be applied to multiple instances of an article. A label may be assigned to be used as an identifier of a distribution channel of a number of articles. A label may be assigned to be used as an indicator of a differentiated group of articles. For example, a label may indicate that a bandage is assigned to a first aid kit which is provided via a particular distribution channel, such as an emergency room, an immediate care facility, a paramedic, a clinic, a pharmacy, and/or a doctor's office. Similarly if a group of items is repackaged for aid distribution, such as for disaster relief, a label may indicate that the item is part of a package of items distributed by an organization such as FEMA, the Red Cross, a food bank, etc. Physical parameters associated with a label may be recorded. For example, a process which is used to affix a label, a technology used to produce a label, and/or security coding associated with a label may be recorded. Control is passed to operation 525 and process 500 continues.

In operation 525 a label is produced. A label may be produced by a printing process. A label may be produced by an engraving process. A label may be produced by a stamping process. In an embodiment, a URL which specifies an identifier assigned to the label may be encoded as a machine readable code which is printed on an article. In an embodiment, a machine readable code is a QR code. A label may be processed subsequent to a production process to cause the label to conform to a set of dimensions. For example, a cutting process such as a shear might be applied to a larger substrate to create a final label. Any suitable process might be applied to ensure that a finished label has a property which is associated with a label. For example, a label might receive a coating, a label might be exposed to radiation and/or thermal curing, and/or a label might be mechanically punched and/or perforated. Control is passed to operation 530 and process 500 continues.

In operation 530 process information is recorded. For example, information which has been recorded on a label may be stored in the media distribution system 125 in association with a UUID assigned to a label. Parameters such as time, location, temperature, origination of a request, batch numbers associated with production components and/or other information gathered during fulfillment of a request may be recorded in any suitable elements of the system 100 (FIG. 1). Control is passed to operation 505 and process 500 continues.

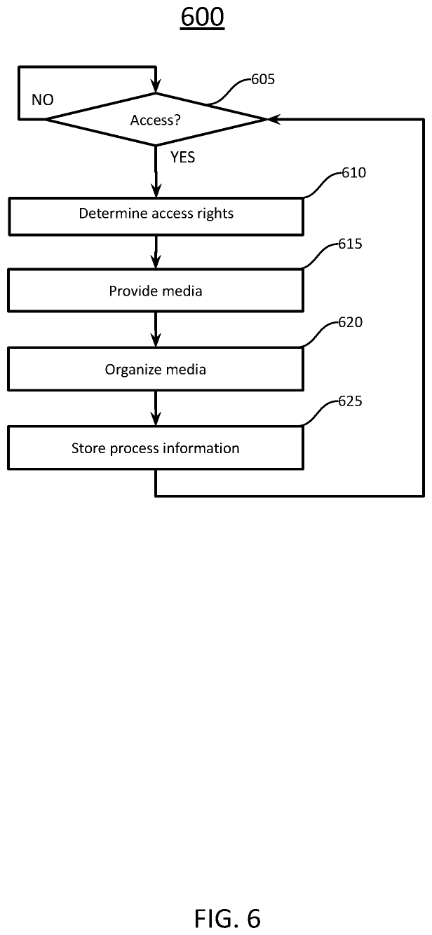

A flowchart of a process 600 for associating a response with an identifier of a persistent label is illustrated in FIG. 6. The process 600 may be operative in whole and/or in part on any suitable element of the system 100 (FIG. 1). In an embodiment, the process 600 is operative on a server associated with the media distribution system 125 (FIG. 1). In an embodiment, elements of the process 600 may be operative on a device such as the distributor system 105 (FIG. 1). In an embodiment, elements of the process 600 may be operative on a device such as the recipient system 120 (FIG. 1). In an embodiment, elements of the process 600 may be operative on a device such as the label production system 130 (FIG. 1).

In operation 605 a determination is made as to whether a request for access to a response associated with a label is received. If in operation 605 it is determined that a request for access to a response associated with a label is received, control is passed to operation 610 and process 600 continues. If in operation 605 it is determined that a request for access to a response associated with a label is not received, control remains at operation 605 and process 600 continues.

The determination in operation 605 may be made based on any suitable criterion. For example, if a request is received at a device associated with the media distribution server 125 (FIG. 1) it may be determined that a request to access a response associated with a label is received. A URL associated with a request may be used to determine whether a request to access a response associated with a label is received. If a request indicates an identifier associated with a label, it may be determined that a request to access a response associated with a label is received. In an embodiment, if an identifier has not been associated with a media file, a user interface which may be used to associate media with an identifier may be presented as a response. In an embodiment, if a plurality of labels are scanned, the determination may be made based on a combination of information encoded in a number of the labels.

In operation 610 access rights associated with a label are determined. In an embodiment, access is write once/read many (WORM) wherein if a media file is not associated with an identifier a media file may be associated with the identifier and thereafter read only access is permitted for that identifier. In an embodiment, a producer of a product may associated a media file with a generic label based on security information provided. For example, a request which may include an identifier associated with a product may permit write access to media associated with a label associated with the product. A recipient might be permitted to associate a media file with an identifier associated with a label, which might cause a message to be provided to a device associated with the identifier. In this way, a two way communication between devices such as the distributor system 105 (FIG. 1) and the recipient system 115 might be established. In an embodiment, an identifier associated with a label might cause a web page designated by a distributor and/or a product or article associated with a label to be presented to a user of a device such as the recipient system 120 (FIG. 1). A distributor and/or a producer of a product might be able to cause a particular media file to be provided based on a combination of information. For example, if a generic product label is scanned and a promotion is associated with the product, a user of a system such as the recipient system 120 might be prompted to scan a differentiated label (e.g., a Point-Of-Sale (POS) marking or a lot number code) which might determine content which is provided. If a promotion had expired, a generic product website and/or response might be presented. Control is passed to operation 615 and process 600 continues.

In operation 615 media is provided. For example, a user interface might be presented as a web page to a browser of a device. An image, a video file, an audio file, text, and/or any other type of media might be provided responsive to a request. Access rights might determine that additional media may be associated with an identifier. Any type of media which may be delivered via the network 135 (FIG. 1) might be provided. A response may be obtained which may generate another request for access. Control is passed to operation 620 and process 600 continues.

In operation 620 media is organized. Media may be organized in any suitable manner. For example, if multiple images are associated with an identifier, the images might be ordered based on chronological data. Likewise media might be organized based on information associated with media when it is received. For example, a user identifier, a geographic location, device information and/or capabilities might be used to determine an order of presentation of media. User responses to a media file might be used to organize media associated with an identifier. For example, a user might search for a particular keyword, image, and/or other data which might change how media is organized. Likewise, a distributor might choose to modify which media is presented and/or an order of presentation based on criteria such as location, time, etc., associated with a request for access. Information of organization of media may be persistent. Control is passed to operation 625 and process 600 continues.

In operation 625 process information is stored. Information associated with the process 600 may be stored in any suitable element of the system 100 (FIG. 1). For example, a browser cookie stored in a browser of a device such as the recipient device 120 might be updated to reflect whether a media file has been presented. Similarly any events which may have occurred during the process 600 might be recorded in a device associated with the media distribution system 125, and/or other elements of the system 100. Control is passed to operation 605 and process 600 continues.

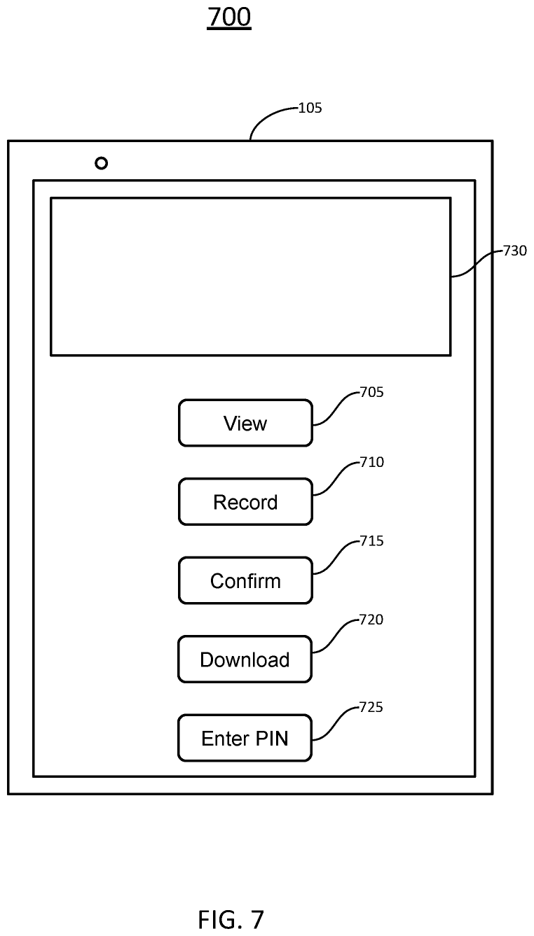

A user interface 700 for associating a response with an identifier is illustrated in FIG. 7. The user interface 700 may be presented via a display device of an element of the system 100 (FIG. 1) such as the distributor system 110, the label production system 130, the media distribution system 125 and/or the recipient system 115. In an embodiment, the user interface 700 is presented as a web page received from a server associated with the media distribution system 125 using a browser functionality of the distributor system 105.

The user interface 700 may comprise a view control 705, a record control 710, a confirm control 715, a download control 720, a security input 725 and a content display area 730. Any of the elements of the user interface 700 may be suppressed as necessary to operate the embodiments. The user Interface 700 may be used to associate a response with a combination of identifiers. For example, an identifier associated with a generic label and an identifier associated with a distributor label might be associated with a response using the user interface 700.

The view control 705 may be used to play a selected media file such as a video file, image, web page, text and/or audio clip. Activation of the view control 705 may cause a media player functionality of a device to be activated. The record control 710 may cause a media recording functionality of a device to be invoked. For example, a video recording interface may be presented when the record control 710 is activated. The confirm control 715 may be used to indicate that a media file is to be associated with a label and/or combination of labels. For example, when the confirm control 715 is activated, a media file may be uploaded to a server to be stored in association with a label, a group or set of labels and/or an identifier. The download control 720 may be used to cause a selected media file to be added to local storage of a device. For example, activation of the download control 720 may cause a file management functionality of a device to be activated. Subsequent to completion of a file management activity, the user interface 700 may be presented.

The security input 725 may allow security information to be provided. For example, a text input might be provided which might be used to enter a printed code associated with a label to permit access to and/or editing of media associated with a label. Similarly the security input 725 may activate a data input functionality of a device. For example, a camera functionality of a device might be used to read a computer readable optical code, a microphone functionality might be activated to obtain audio security information, and/or an RFID reading capability of a device might be used to obtain security information. Any suitable type of input functionality might be accessed to provide security information when the security input 725 is activated. A combination of labels might be scanned when the security input 725 is activated, which might associate a media file with a combination of labels. A distributor might scan a generic label and a distributor label to associate a file with the combination. For example, an immediate care center which dispensed a medication might scan a label associated with the medication and a label associated with the immediate care center, which would allow the immediate care center to associate a referral to a pharmacy, or a follow-up care facility associated with the labels.

The content display area 730 may be used to provide information of media and/or responses associated with a label. For example, a list of media files, thumbnails associated with media files, a list of actions, and/or other information of media associated with a label may be presented using the content display area 730.

A method and system for usage of a persistent label is described. A media server, distributor devices, recipient devices, a label production system and a network are described which may be used in a system for usage of a persistent label. A process for creating and using a persistent label are disclosed. The process may include assigning a unique identifier to a label. The process may comprise encoding a unique identifier in a computer readable symbol which may be applied to a label. The process may comprise associating physical properties of a label with an identifier of a label. A process for creating a package and/or group of items which are associated with a distributor is described. The process of creating a package may comprise associating access information associated with a number of labels with the package and providing that information as an element of the package.

A process for associating a response with an identifier which is assigned to a label is disclosed. The process for associating a response with an identifier may comprise determining the identifier based on a request. The process for associating a response with an identifier may comprise associating a media file with the identifier. The process for associating a response with an identifier may comprise obtaining information of access rights associated with a request and the identifier. The process for associating a response with an identifier may be modified based on physical characteristics associated with a label.

The method and systems herein have been described in a few particular contexts. For example, a system whereby a manufacturer may create a system for ULT which may be used to determine a response to a request which comprises an identifier associated with a particular product and/or group of articles of manufacture is described. This might for example, allow a manufacturer to implement programs to measure customer satisfaction, identify products associated with a recall, administer a promotional program, and/or otherwise trace and interact with recipients of a product.

Similarly, the method and systems have been described in the context of a distribution channel for articles of manufacture. In that context, a facility which distributes a product may differentiate products which are delivered via that facility using a persistent label. For example, an immediate care facility might distribute a medication and/or a medical device which is identified with the facility. A response to a request which identifies a product and the distribution channel may be customized as a result. For example, a referral for further care, instructions for use, and/or follow on assistance, etc., might be created by a distribution channel. A response may be determined based on factors such as geographic location, personally identifying information (PII) of a recipient, insurance coverage of a recipient, etc.

While the systems and methods have been described in a few particular embodiments, no limitation is implied thereby. Various other applications of the methods and systems described herein as would readily occur to one of ordinary skill in the relevant art are within the scope of the systems and methods described herein.

Any or all of the operations described herein may be implemented via one or more hardware components. However, the present invention is not limited to any specific implementation of an operation. For example, one or more operations discussed herein may be implemented via software executed on a device while others may be executed via a specific hardware device. The user interfaces described herein have been illustrated using specific types of controls and/or inputs. However, no limitation is implied thereby. Any suitable controls and/or inputs which might be used to accomplish the functionality described herein might be utilized to implement an embodiment of the systems and processes described herein.

The present invention may be implemented using a program stored, for example, in a computer-readable storage medium such as a CD-ROM, etc., or using one or more specialized terminals, devices or systems that is enabled to execute operation(s) described herein. The storage or recording medium used in an embodiment can be selected from among various computer-readable media including, a disk, a DVD, an internal storage device (memory such as RAM or ROM) in a computer, etc.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc—Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the claimed invention are apparent from the detailed specification and thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A method for using a persistent label comprising:
associating an identifier with a persistent label;
determining a property associated with the persistent label;
receiving information of a response associated with the persistent label; and
providing the response when a request comprising the identifier is received.

2. The method of claim 1 further comprising:
receiving information of a generic identifier of an article of manufacture; and
assigning an identifier to the article of manufacture based on a distribution channel.

3. The method of claim 2 further comprising:
creating the persistent label by printing the persistent label on a package containing an article of manufacture.

4. The method of claim 1 further comprising:
creating the persistent label by molding the persistent label into the article of manufacture.

5. The method of claim 1 further comprising:
determining content of the persistent label; and
applying a label which uniquely identifies an article of manufacture identified by a category associated with the label.

6. The method of claim 1 further comprising:
determining whether the label uniquely identifies an article of manufacture; and
obtaining further information from the article of manufacture to differentiate the article of manufacture.

7. The method of claim 1 further comprising:
applying a marking based on a distribution channel to an item identified by the persistent label; and
providing the response based on the marking.

8. The method of claim 1 further comprising:
determining an article of manufacture indicated by the label; and
modifying the response based on a time interval associated with the article of manufacture.

9. The method of claim 1 further comprising:
creating a marking which specifies a distribution channel and the identifier;
applying the marking to an item; and
providing the response based on the marking.

10. The method of claim 1 wherein:
the label is printed on a package of an article of manufacture.

11. The method of claim 1 wherein:
the property indicates a process whereby the label is attached to an article of manufacture.

12. The method of claim 1 wherein:
the response is a video file; and
the response is determined based on a serial marking of an article of manufacture and the label.

13. A method of using a persistent label comprising:
assigning an identifier to a persistent label;
attaching the persistent label to an article of manufacture;
determining a status of the article of manufacture responsive to a message comprising the identifier received from a device which reads the persistent label;
providing a response associated with a category assigned to the article of manufacture based on the status wherein the response is a generic web page associated with the category as indicated by the status;
presenting media associated with a batch assigned to the article of manufacture based on the status wherein the media is a web page associated with a post sale action associated with the batch as indicated by the status;
communicating a reply associated uniquely with the article of manufacture based on the status wherein the reply is an interactive medium which may elicit feedback by a user of the article of manufacture as indicated by the status and geographic location information associated with the message; and
determining the status based on a selection by a provider of the article of manufacture and temporal information associated with the identifier.

14. A method of using a persistent label comprising:
assigning an identifier to a persistent label;
attaching the persistent label to an article of manufacture based on a distribution channel for the article of manufacture wherein the article of manufacture is a consumable medical device and the distribution channel is controlled by a provider of medical services;
determining a status of the article of manufacture responsive to a message comprising the identifier received from a device which reads the persistent label;
providing a response associated uniquely with the article of manufacture based on the status wherein the response is a video message provided by a purchaser of the article of manufacture;
presenting media associated with the distribution channel of the article of manufacture based on the status wherein the message is a web page associated with a medical service provider as indicated by the status and geographic location information included in the message;
communicating a reply associated with a type assigned to the article of manufacture based on the status; and
determining the status based on a selection by a producer of the article of manufacture, a choice by a purchaser of the article of manufacture, a decision by a distributor associated with the distribution channel and historical information associated with the identifier.

15. The method of claim 1 wherein:
the persistent label is applied to a container of a medication;
the response comprises instructions on use of the medication; and
the response comprises recording temporal information of the usage of the medication.

16. The method of claim 1 wherein:
the persistent label is applied to a container of a medication;
the response comprises instruction on use of the medication which are specific to a person indicated by the request; and
the response comprises recording temporal information of the usage of the medication and sending a message after a pre-determined time interval.

17. The method of claim 1 wherein:
the persistent label is applied to a container of a plurality of medical devices;
the response comprises instructions on use of a member of the plurality of devices; and
the response comprises a referral to a provider of services based on usage information of the member and geographic information associated with the request.

18. The method of claim 1 wherein:
the persistent label is applied to a container of a medical device;
the response comprises instruction on use of the medical device; and
the response comprises storing the instruction in a local storage of a user device.
